(19) United States
(12) Patent Application Publication
(10) Pub. No.: US 2025/0342364 A1
(43) Pub. Date: Nov. 6, 2025

(54) FEDERATED UNSUPERVISED DOMAIN ADAPTATION

(71) Applicants: Politecnico Di Milano, Milano (IT); STMicroelectronics International N.V., Geneva (CH)

(72) Inventors: Beatrice Rossi, Milano (IT); Giorgio Rossi, Carugo (IT); Michele Craighero, Udine (IT); Diego Carrera, Lodi (IT); Giacomo Boracchi, Buccinasco (IT); Pasqualina Fragneto, Burago di Molgora (IT)

(21) Appl. No.: 18/653,800

(22) Filed: May 2, 2024

(51) Int. Cl. G06N 3/098; G06N 3/0895

(52) U.S. Cl. CPC G06N 3/098; G06N 3/0895

(57) ABSTRACT

According to an embodiment, a method for federated unsupervised domain adaptation in training a machine learning model includes an aggregator server creating a global encoder and classification head through end-to-end multi-class classifier training to minimize Mean Squared Error on its labeled data and deriving a covariance matrix from the same data. These global weights and matrix are then distributed to various local client nodes, which each send back their local weights and a covariance matrix based on their unlabeled data. The aggregator server compiles all local weights to form a new global encoder set, averages the received covariance matrices, and then retrains the model with labeled data, employing a tailored loss function that focuses on optimizing the model's performance.

### TECHNICAL FIELD

The present disclosure generally relates to machine learning and, in particular embodiments, to a federated unsupervised domain adaptation (UDA) for machine learning.

### BACKGROUND

Federated Learning (FL) is a machine learning technique that prioritizes a distributed, client-centric model over traditional centralized data aggregation methods. FL tasks often employ publicly available datasets stored on a central server, and datasets gathered locally on numerous distinct clients, leading to various data distributions.

FL distributes an initial machine-learning model from a central server to various client devices in one or more cycles. Each device or client is responsible for individually training the model using its unique, locally stored data sets. Upon completion of local training, the learned local parameters, such as updated weights and biases, are transmitted back to the central server. The original user data remains on the client's device; only model information travels to the server. This ensures that personal and sensitive data are not exposed beyond the confines of the user's device and enhances data privacy and security.

The central server aggregates the updates received from all participating clients. The aggregated information is used to refine and improve the global model—the process may be repeated to improve the global model over multiple cycles. The main goal of FL is to instrumentalize collective learning from all clients for a robust and comprehensive global model that benefits from diverse data inputs.

Accordingly, FL establishes a collaborative yet privacy-aware environment for building machine learning models. It leverages the strengths of distributed computing resources while keeping each user's data contained and secure, addressing one of the cardinal concerns in modern data analytics and Artificial Intelligence (AI)—user privacy.

### SUMMARY

Technical advantages are generally achieved by embodiments of this disclosure, which describe a federated unsupervised domain adaptation for machine learning.

A first aspect relates to a method for training a machine learning model using federated unsupervised domain adaptation (UDA). The method includes generating, by an aggregator server, a first set of global encoder weights and a first classification head for the machine learning model using end-to-end training with a multi-class classifier to minimize a Mean Squared Error on labeled data stored on the aggregator server; calculating, by the aggregator server, a first covariance matrix of features extracted from the labeled data; distributing, by the aggregator server, the first set of global encoder weights and the first covariance matrix to each local client node of a plurality of local client nodes; receiving, by the aggregator server from each local client node, a second covariance matrix, local encoder weights, the second covariance matrix from each local client node corresponding to features extracted from unlabeled data stored therein; aggregating, by the aggregator server from each local client node, each of the local encoder weights from all local client nodes to generate a second set of global encoder weights; generating, by the aggregator server, an aggregated covariance matrix by averaging the second covariance matrix from each local client node; and retraining, by the aggregator server, the machine learning model using the labeled data by minimizing a custom loss function.

A second aspect relates to a method for training a machine learning model using federated unsupervised domain adaptation (UDA). The method includes receiving, by a local client node from an aggregator server, a first set of global encoder weights and a first covariance matrix, the first set of global encoder weights and a first classification head generated by the aggregator server for the machine learning model using end-to-end training with a multi-class classifier to minimize a Mean Squared Error on labeled data stored on the aggregator server, the first covariance matrix being calculated by the aggregator server from features extracted from the labeled data; generating, by the local client node, local encoder weights from the first set of global encoder weights using unlabeled data stored on the local client node; extracting, by the local client node, features from the unlabeled data using the local encoder weights; calculating, by the local client node, a second covariance matrix of the features extracted from the unlabeled data; and communicating, by the local client node to the aggregator server, the second covariance matrix and the local encoder weights.

A third aspect relates to an aggregator server for training a machine learning model using federated unsupervised domain adaptation (UDA). The aggregator server includes a non-transitory memory storage comprising instructions; and a processor in communication with the non-transitory memory storage. The instructions, when executed by the processor, cause the aggregator server to: generate a first set of global encoder weights and a first classification head for the machine learning model using end-to-end training with a multi-class classifier to minimize a Mean Squared Error on labeled data stored on the aggregator server; calculate a first covariance matrix of features extracted from the labeled data; distribute the first set of global encoder weights and the first covariance matrix to each local client node of a plurality of local client nodes; receive, from each local client node, a second covariance matrix, local encoder weights, the second covariance matrix from each local client node corresponding to features extracted from unlabeled data stored therein; aggregate each of the local encoder weights to generate a second set of global encoder weights; generate an aggregated covariance matrix by averaging the second covariance matrix from each local client node; and retrain the machine learning model using the labeled data by minimizing a custom loss function.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of an embodiment system for performing federated learning with unsupervised domain adaptation (UDA);

FIG. 2 is a block diagram of an embodiment aggregator server;

FIG. 3 is a block diagram of an embodiment local client node; and

FIG. 4 is a flow chart of an embodiment method for operating a system in accordance with a federated unsupervised domain adaptation technique to train an encoder in a distributed approach.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of resource-constrained devices such as wearable devices, it should also be appreciated that these inventive aspects may also apply to any device or system that benefits from lightweight machine learning techniques.

Regarding FL and machine learning algorithm training, several challenges emerge due to the need for labeled data on user devices. Data annotation is time-intensive and laborious, with Internet of Things (IoT) devices often needing more user-friendly interfaces to facilitate such labeling efforts. These constraints can pose significant issues given that standard FL practices generally depend on having access to vast quantities of precisely labeled data since most traditional FL models are built upon supervised learning paradigms.

Another hurdle in the deployment of FL is the notable variation in data distribution across clients and between clients and a central server. This variability arises from the distinct contexts in which client data are gathered, which can drastically vary based on the conditions of data collection and may not align with the environment where the server's labeled dataset was curated. Such disparities can affect the effectiveness of model training and the reliability of the learned models when applied to diverse real-world scenarios.

The diversity of clients within an FL framework often means significant limitations regarding the computational resources at their disposal. High-complexity machine learning approaches that perform well in resource-rich environments may not be practical or feasible for client devices, necessitating the development of more lightweight learning techniques that are both effective and computationally economical.

Considering these challenges, Semi-Supervised Federated Learning (SSFL) has gained attention for handling unlabeled raw data, which is more commonly available on client devices. SSFL approaches often generate pseudo-labels to imitate supervised learning; however, this process can place additional computational burdens on clients. Moreover, such approaches lose their effectiveness when client-server data distribution mismatches are present since they typically lack domain adaptation mechanisms. In instances of a pronounced domain discrepancy between the server and client devices, generating pseudo-labels on the client side may prove counterproductive, giving rise to, for example, negative learning. Model trainers with these inaccurately generated labels could exacerbate their performance issues on client devices.

Unsupervised Domain Adaptation (UDA) methodologies seek to bridge the domain gap between the server and client by adjusting for differences in feature distribution between source and target domains. This can be achieved by modeling domain distributions using, for example, first or second-order statistical measures. The modeling can decrease the domain shift by minimizing the Maximum Mean Discrepancy (MMD) loss. Second-order statistical measures can align the mean and the covariance of the source and target distributions. Another approach to minimize domain shift is to employ adversarial loss, which requires the source and target data to be in the same location. Employing adversarial loss results in a model that is discriminative of source labels and domain-agnostic. However, these UDA techniques have been limited to centralized environments and, thus, have not been integrated within a Federated Learning framework.

CORrelation ALignment (CORAL) is an unsupervised domain adaptation technique that aligns the covariance matrices of the source and target domains. Its deep learning variant, DeepCORAL, incorporates this alignment into the architecture of a deep neural network by minimizing the distance between the covariance matrices from the source and target domains. Deep CORAL has proven to be a sophisticated approach for adapting deep neural networks to novel domains, often surpassing other leading domain adaptation methods across various computer vision tasks.

DeepCORAL leverages a two-stream network architecture that allows one stream to learn from the source domain and the other from the target domain. The shared architecture and weights in these streams persist up to a divergence point where the feature representations differ. At this point, a CORAL loss (L_{CORAL}) is computed by evaluating the Frobenius norm of the discrepancy between the correlation matrices of source and target features. The CORAL loss (L_{CORAL}) can be calculated in batches and minimized with a classification loss on labeled source data in an end-to-end training scheme. Minimizing the Frobenius norm encourages the deep neural network to distill features similar between the two domains while retaining its ability to discriminate effectively. The CORAL loss (L_{CORAL}) can be expressed through the equation L_{CORAL}=¼d²∥K_{S}−K_{T}∥_{F}². K_{S} represents the covariance matrix of the source feature set, Kr denotes the covariance matrix of the target feature set, ∥ ∥_{F}² is the squared-Frobenius norm function, and d is the dimensionality of the feature space (i.e., number of features in the feature representation of the data).

Recent advancements in unsupervised FL have sought to tap into the potential of unlabeled client data by learning valuable representations that can be utilized for various tasks. A traditional approach within this realm entails using encoders trained individually on clients' local, unlabeled datasets. These encoders aim to capture salient features of the data, creating representations that encapsulate the underlying structure without being tailored for a specific task. Once local training is complete, the client encoders are sent to a central server, where their parameters are combined using an averaging process to yield a global encoder. The global encoder, thus formed essentially by federating the local models, can then be integrated into a supervised learning framework. Specifically, the encoder portion of this global model serves the purpose of transforming labeled data into feature-rich representations that feed into a subsequent classifier training phase. This encoder-based method provides a distinct edge over pseudo-labeling procedures by generating more generalizable and encompassing data representations.

Even with these advantages, the practical utility of leveraging encoders in FL, especially for tasks like Human Activity Recognition (HAR), has been questioned. Empirical research investigating the application of basic encoders aggregated through the typical Federated Averaging (FedAvg) algorithm has shown limitations. The findings suggest that such aggregated encoder models must consistently capture and represent HAR data across centralized or federated settings. This indicates a gap in efficacy when dealing with real-world scenarios where clients hold datasets that are not only diverse but also unlabeled.

Embodiments of this disclosure propose a solution that overcomes these deficiencies. Aspects of this disclosure are directed to Tiny Machine Learning (TinyML) for resource-constrained devices, such as microcontroller units (MCUs), that benefit from the proposed solution. MCUs are miniature, integrated computing systems typically equipped with a core processor, storage capabilities (memory), and various essential peripherals, making them suitable for many IoT-embedded implementations. TinyML is tailored towards optimizing machine learning models for successful deployment and execution on edge or embedded devices with stringent resource limitations.

In embodiments, a Federated Semi-Supervised Domain Adaptation approach is proposed to address the challenges associated with non-independent and identically distributed (non-IID) datasets in FL. The proposed solution leverages the underlying principles of SSFL (i.e., where clients only possess access to unlabeled raw data, thereby calling for unsupervised strategies) with a Domain Adaptation algorithm, specifically DeepCORAL. These and other details are further detailed below.

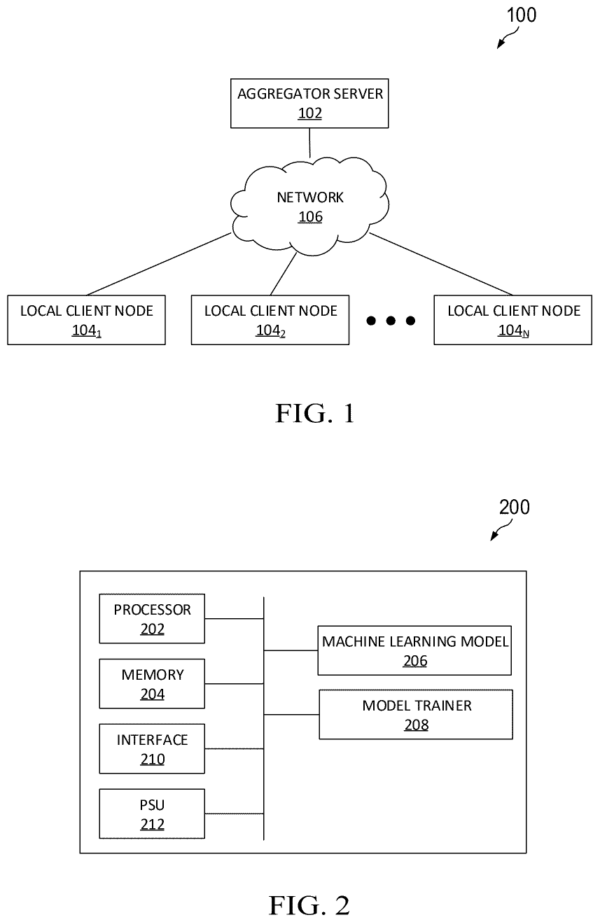

FIG. 1 illustrates a block diagram of an embodiment system 100 for performing federated learning with unsupervised domain adaptation (UDA). System 100 includes an aggregator server 102 and N number of local client nodes 1041, 1042, . . . 104N, where Nis an integer greater than one, which may (or may not) be arranged as shown. In embodiments, the aggregator server 102 and the local client nodes 104 are communicatively coupled via a network 106. System 100 may include additional components that are not shown.

In embodiments, aggregator server 102 is implemented using multiples of aggregator server. In embodiments, each aggregator server operates based on sequential, parallel, or a combination thereof types of computing architectures.

Local client node 104 can be any type of computing device, such as a desktop or laptop used as a personal computing device, mobile devices like smartphones or tablets, controllers or consoles for gaming, devices worn on the body or embedded within other systems, internet of things (IoT) type devices, or the like.

Network 106 can include various communications networks, such as a local area network (e.g., intranet), wide area network (e.g., Internet), or a combination thereof. It can include any number of wired or wireless links. Communication over network 106 can be carried via any type of wired or wireless connection. Data sent across network 106 can adhere to one or more communication protocols, such as TCP/IP, HTTP, SMTP, and FTP; employ various data types and structures like HTML or XML; and apply different security measures, including VPN, secure HTTP, SSL encryption to ensure protected transmissions.

The aggregator server 102 and each of the local client nodes 1041, 1042, . . . 104N can be located at the same or different physical locations (i.e., not necessarily in the same location). Further, one or more local client nodes 1041, 1042, . . . 104N can be located at the same or different physical locations.

In embodiments, the aggregator server 102 is configured to generate an initial global machine learning model. The global machine learning model and one or more related parameters are communicated via network 106 to the local client nodes 1041, 1042, . . . 104N, or a subset thereof. Each local client node 104 that receives the information from the aggregator server 102 is configured to modify the global machine learning model with locally stored data to generate a modified local machine learning model, which is communicated back to the aggregator server with one or more related parameters—the locally stored data remains at the local client node. The aggregator server 102 receives the multiple machine learning models locally modified by the local client nodes and aggregates them to generate an updated global machine learning model. The process is repeated until a convergence criterion is satisfied.

FIG. 2 illustrates a block diagram of an embodiment aggregator server 200, which may be implemented as the aggregator server 102 in system 100. Aggregator server 200 includes a processor 202, a memory 204, a machine learning model 206, a model trainer 208, an interface 210, and a power supply unit (PSU) 212, which may (or may not) be arranged as shown. In embodiments, aggregator server 200 may include additional components not shown.

Processor 202 may be any component or collection of components adapted to perform computations or other processing-related tasks. In embodiments, processor 202 is an application processor, a baseband processor, a microcontroller, a processor core, a microprocessor, an application-specific integrated circuit (ASIC), a field programmable gate array (FPGA), control circuitry, or the like. In embodiments, aggregator server 200 includes more than one processor, and the various tasks may be shared or designated between the multiple processors.

Memory 204 may be any component or collection of components adapted to store programming or instructions for execution by processor 202. In an embodiment, memory 204 includes a non-transitory computer-readable medium. In embodiments, memory 204 is configured to store local data for analysis by, for example, the processor 202. For example, local data can be healthcare information, financial records from banking operations, details of e-commerce transactions, data (e.g., voice) related to Internet of Thing (IoT) devices, or data from online transactions. In embodiments, the local data can be used to train machine learning algorithms.

The data can be time series collected from various types of sensors, including gyroscopes, accelerometers, blood pressure sensors, or temperature sensors, which monitor human activity. In embodiments, the input data for the model maintains uniformity across all clients, meaning that if sensors from different clients gather data at varying sampling rates, the data is resampled to ensure a consistent sampling frequency for all.

The machine learning model 206 can take various forms, such as neural network architectures and multi-layer linear or non-linear models. In embodiments, the neural network may include feed-forward neural networks, recurrent (long short-term memory (LSTM) neural networks, deep neural networks, convolutional neural networks, and the like.

In embodiments, the machine learning model 206 is a global machine learning model stored in memory 204. In embodiments, the machine learning model 206 is executed by the processor 202. In embodiments, the global variant of the machine learning model 206 is utilized to compute predictions or refine them through training on the aggregator server 200. In embodiments, the modified global variant of the machine learning model 206 is communicated to the local client nodes 1041, 1042, . . . 104N via the network 106. In embodiments, aggregator server 200 can run multiple concurrent versions of a single machine-learning model 206.

The model trainer 208 is configured to refine the machine learning model 206. In embodiments, the model trainer 208 utilizes various training methods, such as error backpropagation. Model updates might occur through a loss function backpropagated to adjust model parameters using different loss functions, including mean squared error, likelihood loss, cross-entropy loss, and hinge loss, among others. Parameter adjustment can be achieved through iterative gradient descent techniques. In embodiments, error backpropagation involves truncated methods when considering sequences over time. In embodiments, model trainer 208 applies various generalization strategies, such as weight decay or dropout techniques, to enhance the predictive performance of the machine learning model 206. The optimization strategies the model trainer 208 uses can be adaptive or fixed.

In embodiments, model trainer 208 includes computer logic to perform its functions, which can be hardware, firmware, or software managing a general-purpose processor, such as processor 202. For example, model trainer 208 can operate from software stored in memory 204 and executed by processor 202. As another example, model trainer 208 includes instructions stored in memory 204.

Interface 210 may be any component or collection of components that allows processor 202 to communicate with other devices/components or a user. For example, interface 210 may be adapted to enable the aggregator server 200 to interact with the local client nodes 1041, 1042, . . . 104N of the system 100 via the network 106. Interface 210 may include one or more components that allow interactions (e.g., visual, audible, etc.) with a user, such as a display interface, a microphone, a speaker, a gesture recognition circuit, a keyboard, a mouse, or the like.

Power supply unit 212 may be any component or collection of components that provides power to one or more components within aggregator server 200. It may include various power management circuitry, charge storage components (e.g., battery), and the like.

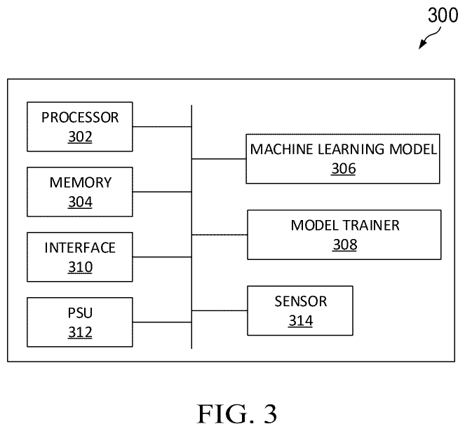

FIG. 3 illustrates a block diagram of an embodiment local client node 300, which may be implemented as the local client node 104 in system 100. Local client node 300 includes a processor 302, a memory 304, a machine learning model 306, a model trainer 308, an interface 310, a power supply unit (PSU) 312, and a sensor 314, which may (or may not) be arranged as shown. In embodiments, local client node 300 may include additional components not shown.

Processor 302 may be any component or collection of components adapted to perform computations or other processing-related tasks. In embodiments, processor 302 is an application processor, a baseband processor, a microcontroller, a processor core, a microprocessor, an application-specific integrated circuit (ASIC), a field programmable gate array (FPGA), control circuitry, or the like. In embodiments, the local client node 300 includes more than one processor, and the various tasks may be shared or designated between the multiple processors.

Memory 304 may be any component or collection of components adapted to store programming or instructions for execution by processor 302. In an embodiment, memory 304 includes a non-transitory computer-readable medium. In embodiments, memory 304 is configured to store local data for analysis by, for example, the processor 302. For example, local data can be healthcare information, financial records from banking operations, details of e-commerce transactions, data (e.g., voice) related to Internet of Things (IoTs) devices, or data from online transactions. In embodiments, the local data can be used to train machine learning algorithms.

The data can be time series collected from various types of sensors, including gyroscopes, accelerometers, blood pressure sensors, or temperature sensors, which monitor human activity. In embodiments, the input data for the model maintains uniformity across all clients, meaning that if sensors from different clients gather data at varying sampling rates, the data is resampled to ensure a consistent sampling frequency for all.

The machine learning model 306 can take various forms, such as neural network architectures and multi-layer linear or non-linear models. In embodiments, the neural network may include feed-forward neural networks, recurrent (long short-term memory (LSTM) neural networks, deep neural networks, convolutional neural networks, and the like.

In embodiments, the machine learning model 306 is downloaded from the aggregator server 102 via the network 106. In embodiments, the machine learning model 306 is stored in memory 304. In embodiments, the machine learning model 306 is executed by the processor 302. In embodiments, the local variant of the machine learning model 306 is utilized to compute predictions or refined through training on the local client node 300. In embodiments, the modified local variant of the machine learning model 306 is communicated to the aggregator server 102 via the network 106. In embodiments, the local client node 300 can run multiple concurrent versions of a single machine-learning model 306.

The model trainer 308 is configured to refine the machine learning model 306. In embodiments, the model trainer 308 utilizes various training methods, such as error backpropagation. Model updates might occur through a loss function backpropagated to adjust model parameters using different loss functions, including mean squared error, likelihood loss, cross-entropy loss, and hinge loss, among others. Parameter adjustment can be achieved through iterative gradient descent techniques. In embodiments, error backpropagation involves truncated methods when considering sequences over time. In embodiments, model trainer 308 applies various generalization strategies, such as weight decay or dropout techniques, to enhance the predictive performance of the machine learning model 306. The optimization strategies the model trainer 308 uses can be adaptive or fixed.

In embodiments, model trainer 308 includes computer logic to perform its functions, which can be hardware, firmware, or software managing a general-purpose processor, such as processor 302. For example, model trainer 308 can operate from software stored in memory 304 and executed by processor 302. As another example, model trainer 308 includes instructions stored in memory 304.

Interface 310 may be any component or collection of components that allows processor 302 to communicate with other devices/components or a user. For example, interface 310 may be adapted to enable the local client node 300 to interact with the aggregator server 102 of the system 100 via the network 106. Interface 310 may include one or more components that allow interactions (e.g., visual, audible, etc.) with a user, such as a display interface, a microphone, a speaker, a gesture recognition circuit, a keyboard, a mouse, or the like.

Power supply unit 312 may be any component or collection of components that provides power to one or more components within the local client node 300. It may include various power management circuitry, charge storage components (e.g., battery), and the like.

Sensor 314 may be any type of sensor such as a gyroscope, an accelerometer, a blood pressure sensor, or a temperature sensor used to, for example, collect data related to human activity.

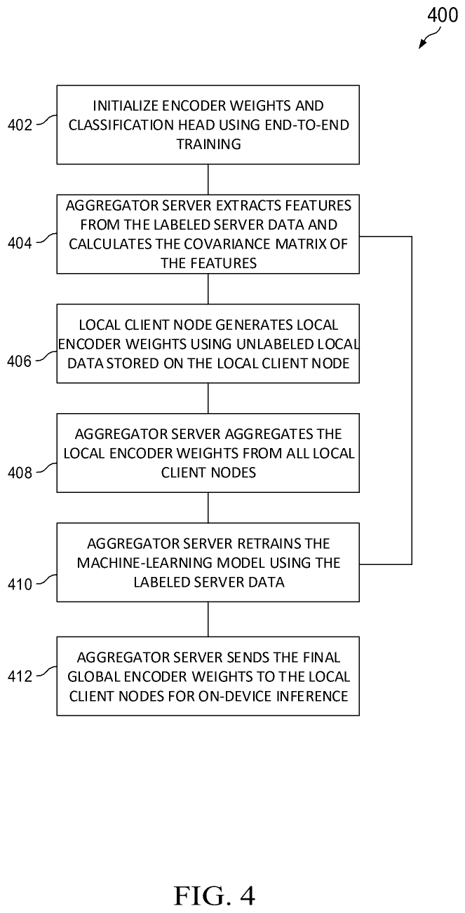

FIG. 4 illustrates a flow chart of an embodiment method 400 for operating the system 100 in accordance with a federated unsupervised domain adaptation technique to train an encoder in a distributed approach. It is noted that all steps outlined in the flow chart are not necessarily required and can be optional. Further, changes to the arrangement of the steps, removal of one or more steps and path connections, and addition of steps and path connections are similarly contemplated.

At step 402, an aggregator server initializes encoder weights (w_{E}^{S}) and the classification head using end-to-end training with a multi-class classifier to minimize the Mean Squared Error (MSE) on a labeled server data (X^{S}, Y^{S}) stored on the aggregator server (i.e., training set). The initialization of the encoder weights (w_{E}^{S}) and the classification head is achieved by performing an end-to-end training by minimizing the Classification Loss (L_{CLASS}).

End-to-end training refers to integrating the encoder weights (w_{E}^{S}) and the classification head into a unified model, which is then concurrently trained using labeled server data (X^{S}, Y^{S}).

At step 404, the aggregator server utilizes the global encoder weights (w_{E}^{S}) to extract features from the labeled server data (X^{S}, Y^{S}) and calculate the covariance matrix (K_{S}) of the features. The aggregator server distributes the global encoder weights (w_{E}^{S}) and the covariance matrix (K_{S}) to each local client node.

At step 406, each local client node performs a local update of the received encoder weights (w_{E}^{S}) to update local encoder weights (w_{E}ⁿ) using unlabeled local data (Xⁿ) stored on the local client node. In embodiments, each local client node 104 updates the local encoder weights (w_{E}ⁿ) by minimizing the CORAL loss (L_{CORAL})—no labeled data stored at the local client nodes.

In particular, the global encoder weights (w_{E}^{S}) are locally updated by each local client node to generate local encoder weights (w_{E}ⁿ). Each local client node processes the unlabeled local data (Xⁿ) in batches (i.e., the unlabeled local data is split into batches and each batch is processed separately). For each batch, the local client node computes a covariance matrix (Kₙ) of the features extracted by a current version of the local encoder weights (w_{E}ⁿ). The local encoder weights (w_{E}ⁿ) are updated to minimize the CORAL loss (L_{CORAL}) between the computed covariance matrix (Kₙ) and the covariance matrix (K_{S}) of the features extracted from labeled server data (X^{S}). The process is iterated over several batches until the entirety of the unlabeled local data (Xⁿ) is processed. Once the entirety of the unlabeled local data (Xⁿ) is processed, a covariance matrix (Kₙ) of the features extracted by the last version of the local encoder weights (w_{E}ⁿ) is computed over the entire unlabeled local data (Xⁿ).

Each local client node sends the covariance matrix (Kₙ) of the features extracted from the unlabeled local data (Xⁿ), the local encoder weights (w_{E}ⁿ), the mean of the features extracted from the unlabeled local data (Xⁿ), and the number of samples (S) used to generate the local encoder weights (w_{E}ⁿ).

At step 408, the aggregator server aggregates the local encoder weights (w_{E}ⁿ) from all local client nodes via, for example, Federated Averaging to generate updated global encoder weights (w_{E}^{S′}). In addition, the aggregator server generates an aggregated covariance matrix (\hat{K}) by averaging the covariance matrix (Kₙ) from each local client node.

At step 410, the aggregator server retrains the machine-learning model (i.e., the global encoder weights and classification head) using the labeled server data (X^{S}, Y^{S}) for a few epochs (e.g., ten epochs) by minimizing the custom loss (L) function. Advantageously, this allows for alignment between the aggregated covariance matrix (\hat{K}) and the covariance matrix (K_{S}′) of the features extracted from the labeled server data (X^{S}, Y^{S}).

In embodiments, a custom loss (L) function is introduced that combines the Classification Loss (L_{CLASS}) and the weighted CORAL loss (L_{CORAL}), which can be represented by the equation: L=L_{CLASS}+λ×L_{CORAL}, where λ is a regularization parameter. In embodiments, the regularization parameter (λ) is set to one-due to the order of magnitude of the Classification Loss (L_{CLASS}) and the weighted CORAL loss (L_{CORAL}) being approximately equal.

The retraining results in updated global encoder weights (w_{E}^{S″}) and updated classification head. Accordingly, the aggregator server adjusts the parameters of the machine learning model by minimizing the custom loss (L) function to reduce (i) the discrepancy between predicted and actual labels for the data points in the labeled server data (X^{S}, Y^{S}) and (ii) the distance between the covariance matrix (Kₙ) of the features extracted from unlabeled local data (Xⁿ) and the covariance matrix (K_{S}) of the features extracted from labeled server data (X^{S}, Y^{S}).

In embodiments, steps 404-410 are repeated to refine the global encoder weights (w_{E}^{S″}). Each round allows further alignments and adjustments.

Finally, at step 412, the aggregator server sends the final global model (i.e. the encoder weights (w_{E}^{S″}) and the classification head) to the local client nodes for on-device inference (i.e., the classification prediction being performed on the local client node).

Aspects of this disclosure can advantageously apply to Human Activity Recognition (HAR) using data from wearable devices, such as triaxial accelerometers. HAR illustrates the challenges encountered when training deep learning models within distributed frameworks. In these real-world applications, users continually generate raw personal data, rendering the labeling process impractical and laborious. Furthermore, HAR is complicated by the pronounced need for labels in client-generated data.

The scenario is further exacerbated by two prevalent issues in distributed learning environments: client heterogeneity and domain shift. These challenges arise when different users collect data with their sensors, which often vary from the sensors used to collect the labeled dataset on the server. This disparity leads to a mismatch in data distribution between clients and the server. Moreover, each individual has distinct physical characteristics that influence activities, adding a layer of complexity to the task. Client heterogeneity is also evident in the differing placements of wearable devices on the body, contributing to variations in detected activity patterns.

Advantageously, embodiments of the present disclosure address challenges such as domain shift and client heterogeneity in conventional FL techniques for machine learning. For example, the proposed approach incorporates a method that uses unlabeled client data, which helps to protect the integrity of the global model by mitigating the risk associated with adversarial clients who may attempt to compromise the model through the deliberate mislabeling of data.

A significant improvement in the proposed solution is the capability to train a classification model end-to-end on a server without splitting training between an encoder and a classification head. This advancement enhances the system's accuracy, providing a clear edge over conventional solutions.

In tackling the domain shift problem inherent to FL, which is compounded by privacy and memory limitations on local client devices, the present disclosure offers a strategic approach by limiting the shared communication to just the weights of the encoder, the quantity of data used, and the mean and covariance matrix of extracted features between the server and the local client nodes. This strategy effectively maintains user data privacy, as the covariance matrix does not allow the reconstruction of original data stored in the local client node. Additionally, it ensures that the updated model stays within the original data distribution.

A first aspect relates to a method for training a machine learning model using federated unsupervised domain adaptation (UDA). The method includes generating, by an aggregator server, a first set of global encoder weights and a first classification head for the machine learning model using end-to-end training with a multi-class classifier to minimize a Mean Squared Error on labeled data stored on the aggregator server; calculating, by the aggregator server, a first covariance matrix of features extracted from the labeled data; distributing, by the aggregator server, the first set of global encoder weights and the first covariance matrix to each local client node of a plurality of local client nodes; receiving, by the aggregator server from each local client node, a second covariance matrix, local encoder weights, the second covariance matrix from each local client node corresponding to features extracted from unlabeled data stored therein; aggregating, by the aggregator server from each local client node, each of the local encoder weights from all local client nodes to generate a second set of global encoder weights; generating, by the aggregator server, an aggregated covariance matrix by averaging the second covariance matrix from each local client node; and retraining, by the aggregator server, the machine learning model using the labeled data by minimizing a custom loss function.

In a first implementation of the method according to the first aspect, the method further includes receiving, by the aggregator server from each local client node, a mean of features extracted by the local client node from unlabeled data stored therein, and a number of samples used to generate the local encoder weights.

In a second implementation of the method according to the first aspect as such or any preceding implementation form of the first aspect, the aggregating comprises using federated averaging techniques.

In a third implementation of the method according to the first aspect as such or any preceding implementation form of the first aspect, the custom loss function comprises a classification loss and a weighted CORAL loss.

In a fourth implementation of the method according to the first aspect as such or any preceding implementation form of the first aspect, the method further includes adjusting the first set of global encoder weights by minimizing the custom loss function to reduce a discrepancy between predicted and actual labels of the labeled data stored on the aggregator server.

In a fifth implementation of the method according to the first aspect as such or any preceding implementation form of the first aspect, the method further includes generating, by the aggregator server, a second set of global encoder weights and a second classification head for the machine learning model using end-to-end training with the multi-class classifier to align the aggregated covariance matrix and the second covariance matrix.

In a sixth implementation of the method according to the first aspect as such or any preceding implementation form of the first aspect, the method further includes generating, by the aggregator server, a final set of global encoder weights; extracting, by the aggregator server, labeled features from the labeled data stored on the aggregator server using the final set of global encoder weights; training, by the aggregator server, a classifier by minimizing a task-specification Classification Loss until convergence is achieved; and communicating, by the aggregator server to each local client node, the final set of global encoder weights.

A second aspect relates to a method for training a machine learning model using federated unsupervised domain adaptation (UDA). The method includes receiving, by a local client node from an aggregator server, a first set of global encoder weights and a first covariance matrix, the first set of global encoder weights and a first classification head generated by the aggregator server for the machine learning model using end-to-end training with a multi-class classifier to minimize a Mean Squared Error on labeled data stored on the aggregator server, the first covariance matrix being calculated by the aggregator server from features extracted from the labeled data; generating, by the local client node, local encoder weights from the first set of global encoder weights using unlabeled data stored on the local client node; extracting, by the local client node, features from the unlabeled data using the local encoder weights; calculating, by the local client node, a second covariance matrix of the features extracted from the unlabeled data; and communicating, by the local client node to the aggregator server, the second covariance matrix and the local encoder weights.

In a first implementation of the method according to the second aspect, the method further includes generating, by the local client node, the local encoder weights by minimizing a CORAL loss.

In a second implementation of the method according to the second aspect as such or any preceding implementation form of the second aspect, the method further includes communicating, by the local client node to the aggregator server, a mean of features extracted by the local client node from the unlabeled data, and a number of samples used to generate the local encoder weights.

In a third implementation of the method according to the second aspect as such or any preceding implementation form of the second aspect, the unlabeled data is Human Activity Recognition (HAR) type of data.

In a fourth implementation of the method according to the second aspect as such or any preceding implementation form of the second aspect, the unlabeled data is collected using one or more sensors of a wearable device.

In a fifth implementation of the method according to the second aspect as such or any preceding implementation form of the second aspect, the unlabeled data remain are not communicated with the aggregator server from the local client node, and the aggregator server cannot recreate the unlabeled data using information sent from the local client node.

A third aspect relates to an aggregator server for training a machine learning model using federated unsupervised domain adaptation (UDA). The aggregator server includes a non-transitory memory storage comprising instructions; and a processor in communication with the non-transitory memory storage. The instructions, when executed by the processor, cause the aggregator server to: generate a first set of global encoder weights and a first classification head for the machine learning model using end-to-end training with a multi-class classifier to minimize a Mean Squared Error on labeled data stored on the aggregator server; calculate a first covariance matrix of features extracted from the labeled data; distribute the first set of global encoder weights and the first covariance matrix to each local client node of a plurality of local client nodes; receive, from each local client node, a second covariance matrix, local encoder weights, the second covariance matrix from each local client node corresponding to features extracted from unlabeled data stored therein; aggregate each of the local encoder weights to generate a second set of global encoder weights; generate an aggregated covariance matrix by averaging the second covariance matrix from each local client node; and retrain the machine learning model using the labeled data by minimizing a custom loss function.

In a first implementation of the aggregator server according to the third aspect, the instructions, when executed by the processor, cause the aggregator server to receive, from each local client node, a mean of features extracted by the local client node from unlabeled data stored therein, and a number of samples used to generate the local encoder weights.

In a second implementation of the aggregator server according to the third aspect as such or any preceding implementation form of the third aspect, the aggregating comprising using federated averaging techniques.

In a third implementation of the aggregator server according to the third aspect as such or any preceding implementation form of the third aspect, the custom loss function comprises a classification loss and a weighted CORAL loss.

In a fourth implementation of the aggregator server according to the third aspect as such or any preceding implementation form of the third aspect, the instructions, when executed by the processor, cause the aggregator server to adjust the first set of global encoder weights by minimizing the custom loss function to reduce a discrepancy between predicted and actual labels of the labeled data stored on the aggregator server.

In a fifth implementation of the aggregator server according to the third aspect as such or any preceding implementation form of the third aspect, the instructions, when executed by the processor, cause the aggregator server to generate a second set of global encoder weights and a second classification head for the machine learning model using end-to-end training with the multi-class classifier to align the aggregated covariance matrix and the second covariance matrix.

In a sixth implementation of the aggregator server according to the third aspect as such or any preceding implementation form of the third aspect, the instructions, when executed by the processor, cause the aggregator server to: generate a final set of global encoder weights; extract labeled features from the labeled data stored on the aggregator server using the final set of global encoder weights; train a classifier by minimizing a task-specification Classification Loss until convergence is achieved; and communicate, to each local client node, the final set of global encoder weights.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A method for training a machine learning model using federated unsupervised domain adaptation (UDA), the method comprising:
generating, by an aggregator server, a first set of global encoder weights and a first classification head for the machine learning model using end-to-end training with a multi-class classifier to minimize a Mean Squared Error on labeled data stored on the aggregator server;
calculating, by the aggregator server, a first covariance matrix of features extracted from the labeled data;
distributing, by the aggregator server, the first set of global encoder weights and the first covariance matrix to each local client node of a plurality of local client nodes;
receiving, by the aggregator server from each local client node, a second covariance matrix, local encoder weights, the second covariance matrix from each local client node corresponding to features extracted from unlabeled data stored therein;
aggregating, by the aggregator server from each local client node, each of the local encoder weights from all local client nodes to generate a second set of global encoder weights;
generating, by the aggregator server, an aggregated covariance matrix by averaging the second covariance matrix from each local client node; and
retraining, by the aggregator server, the machine learning model using the labeled data by minimizing a custom loss function.

2. The method of claim 1, further comprising receiving, by the aggregator server from each local client node, a mean of features extracted by the local client node from unlabeled data stored therein, and a number of samples used to generate the local encoder weights.

3. The method of claim 1, wherein the aggregating comprising using federated averaging techniques.

4. The method of claim 1, wherein the custom loss function comprises a classification loss and a weighted CORAL loss.

5. The method of claim 1, further comprising adjusting the first set of global encoder weights by minimizing the custom loss function to reduce a discrepancy between predicted and actual labels of the labeled data stored on the aggregator server.

6. The method of claim 1, further comprising generating, by the aggregator server, a second set of global encoder weights and a second classification head for the machine learning model using end-to-end training with the multi-class classifier to align the aggregated covariance matrix and the second covariance matrix.

7. The method of claim 1, further comprising:
generating, by the aggregator server, a final set of global encoder weights;
extracting, by the aggregator server, labeled features from the labeled data stored on the aggregator server using the final set of global encoder weights;
training, by the aggregator server, a classifier by minimizing a task-specification Classification Loss until convergence is achieved; and
communicating, by the aggregator server to each local client node, the final set of global encoder weights.

8. A method for training a machine learning model using federated unsupervised domain adaptation (UDA), the method comprising:
receiving, by a local client node from an aggregator server, a first set of global encoder weights and a first covariance matrix, the first set of global encoder weights and a first classification head generated by the aggregator server for the machine learning model using end-to-end training with a multi-class classifier to minimize a Mean Squared Error on labeled data stored on the aggregator server, the first covariance matrix being calculated by the aggregator server from features extracted from the labeled data;
generating, by the local client node, local encoder weights from the first set of global encoder weights using unlabeled data stored on the local client node;
extracting, by the local client node, features from the unlabeled data using the local encoder weights;
calculating, by the local client node, a second covariance matrix of the features extracted from the unlabeled data; and
communicating, by the local client node to the aggregator server, the second covariance matrix and the local encoder weights.

9. The method of claim 8, further comprising generating, by the local client node, the local encoder weights by minimizing a CORAL loss.

10. The method of claim 8, further comprising communicating, by the local client node to the aggregator server, a mean of features extracted by the local client node from the unlabeled data, and a number of samples used to generate the local encoder weights.

11. The method of claim 8, wherein the unlabeled data is Human Activity Recognition (HAR) type of data.

12. The method of claim 11, wherein the unlabeled data is collected using one or more sensors of a wearable device.

13. The method of claim 8, wherein the unlabeled data remain are not communicated with the aggregator server from the local client node, and the aggregator server cannot recreate the unlabeled data using information sent from the local client node.

14. An aggregator server for training a machine learning model using federated unsupervised domain adaptation (UDA), the aggregator server comprising:
a non-transitory memory storage comprising instructions; and
a processor in communication with the non-transitory memory storage, wherein the instructions, when executed by the processor, cause the aggregator server to:
generate a first set of global encoder weights and a first classification head for the machine learning model using end-to-end training with a multi-class classifier to minimize a Mean Squared Error on labeled data stored on the aggregator server;
calculate a first covariance matrix of features extracted from the labeled data;
distribute the first set of global encoder weights and the first covariance matrix to each local client node of a plurality of local client nodes;
receive, from each local client node, a second covariance matrix, local encoder weights, the second covariance matrix from each local client node corresponding to features extracted from unlabeled data stored therein;
aggregate each of the local encoder weights to generate a second set of global encoder weights;
generate an aggregated covariance matrix by averaging the second covariance matrix from each local client node; and
retrain the machine learning model using the labeled data by minimizing a custom loss function.

15. The aggregator server of claim 14, wherein the instructions, when executed by the processor, cause the aggregator server to receive, from each local client node, a mean of features extracted by the local client node from unlabeled data stored therein, and a number of samples used to generate the local encoder weights.

16. The aggregator server of claim 14, wherein the aggregating comprising using federated averaging techniques.

17. The aggregator server of claim 14, wherein the custom loss function comprises a classification loss and a weighted CORAL loss.

18. The aggregator server of claim 14, wherein the instructions, when executed by the processor, cause the aggregator server to adjust the first set of global encoder weights by minimizing the custom loss function to reduce a discrepancy between predicted and actual labels of the labeled data stored on the aggregator server.

19. The aggregator server of claim 14, wherein the instructions, when executed by the processor, cause the aggregator server to generate a second set of global encoder weights and a second classification head for the machine learning model using end-to-end training with the multi-class classifier to align the aggregated covariance matrix and the second covariance matrix.

20. The aggregator server of claim 14, wherein the instructions, when executed by the processor, cause the aggregator server to:
generate a final set of global encoder weights;
extract labeled features from the labeled data stored on the aggregator server using the final set of global encoder weights;
train a classifier by minimizing a task-specification Classification Loss until convergence is achieved; and
communicate, to each local client node, the final set of global encoder weights.
